(19) United States
(12) Patent Application Publication
(10) Pub. No.: US 2017/0345031 A1
(43) Pub. Date: Nov. 30, 2017

(54) LOCATION CONTEXT AWARE COMPUTING

(71) Applicant: NCR Corporation, Duluth, GA (US)

(72) Inventors: Yehoshua Zvi Licht, Alpharetta, GA (US); David Allen Turner, Fort Worth, TX (US); Joseph Arnold White, Encinitas, CA (US)

(21) Appl. No.: 15/166,740

(22) Filed: May 27, 2016

(51) Int. Cl. G06Q 30/02; G06Q 10/10; G06F 17/30; G06Q 20/20

(52) U.S. Cl. CPC G06Q 30/0203; G06Q 20/202; G06Q 10/109; G06F 17/30241; G06F 17/3053; G06F 17/30528; G06F 17/3097

(57) ABSTRACT

A current location of a consumer is combined with a context aware mapping of the consumer to a current context that the consumer is in at the current location. A real-time suggestion is provided to the consumer based on a likely suggestion that the consumer is predicted to respond to at that location and within that context. Feedback with respect to the suggestion is record and processed for altering the types of real-time suggestions subsequent made to the consumer when the consumer is again at the current location within the context, thereby providing dynamic real-time location context aware computing with respect to the consumer and the real-time suggestions with learning through the feedback.

### BACKGROUND

Nearly everything about a consumer is being captured daily and private information about the consumer is stored on a variety of online-accessible services. In fact, almost every aspect of a consumer's activity and habits is being captured in electronic format somewhere at any given point in time.

Today, consumers engage in transactions across multiple different lines of business. These transactions are recorded separately, the systems that record them have little to no knowledge of each other or, even, the consumer.

In addition, location-based consumer processing exists in the industry. But, these solutions are based on simple location triggers without regard to a consumer's context in any given situation. Moreover, these solutions are built to solve a specific problem and are not built as a generalized and flexible platform. In fact, the solutions provided today are relevant to a specific business and provide no real consumer context beyond a consumer's location.

Moreover, no solution combines consumer contexts beyond location and a specific business solution with multiple consumer channel activity for multiple lines of business.

### SUMMARY

In various embodiments, location context aware computing techniques are presented.

According to an embodiment, a method for location context aware computing is provided. Specifically, in an embodiment, a current location and current context for a consumer are matched to a pattern for the consumer. Next, a real-time suggestion is delivered to the consumer based on the pattern.

### BRIEF DESCRIPTION OF THE DRAWINGS

FIG. 1A is a diagram of a system for location context aware computing, according to an example embodiment.

FIG. 1B is a diagram a sample architecture for practicing location context aware computing according to an example embodiment.

FIG. 2 is a diagram of a method for location context aware computing, according to an example embodiment.

FIG. 3 is a diagram of another method for location context aware computing, according to an example embodiment.

FIG. 4 is a diagram of a system for location context aware computing, according to an example embodiment.

### DETAILED DESCRIPTION

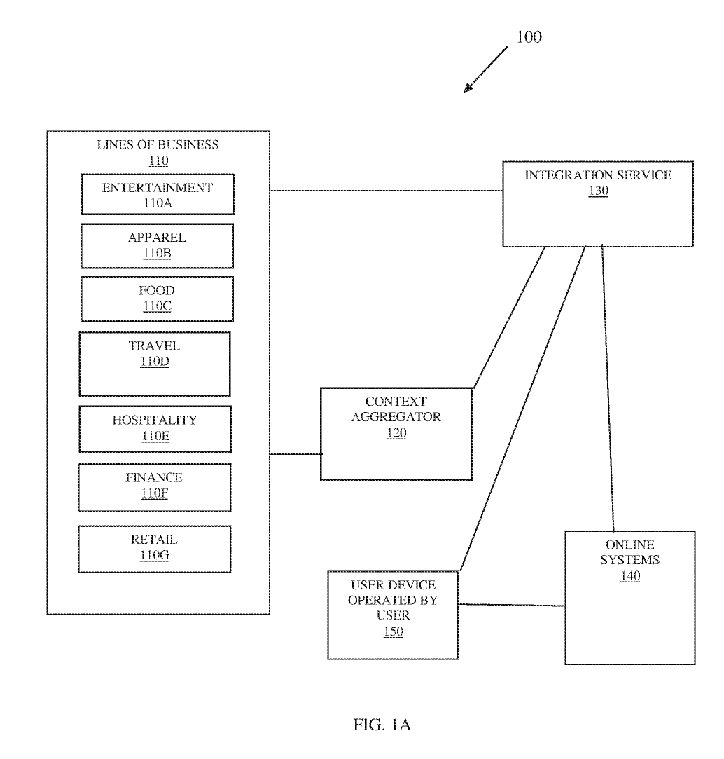

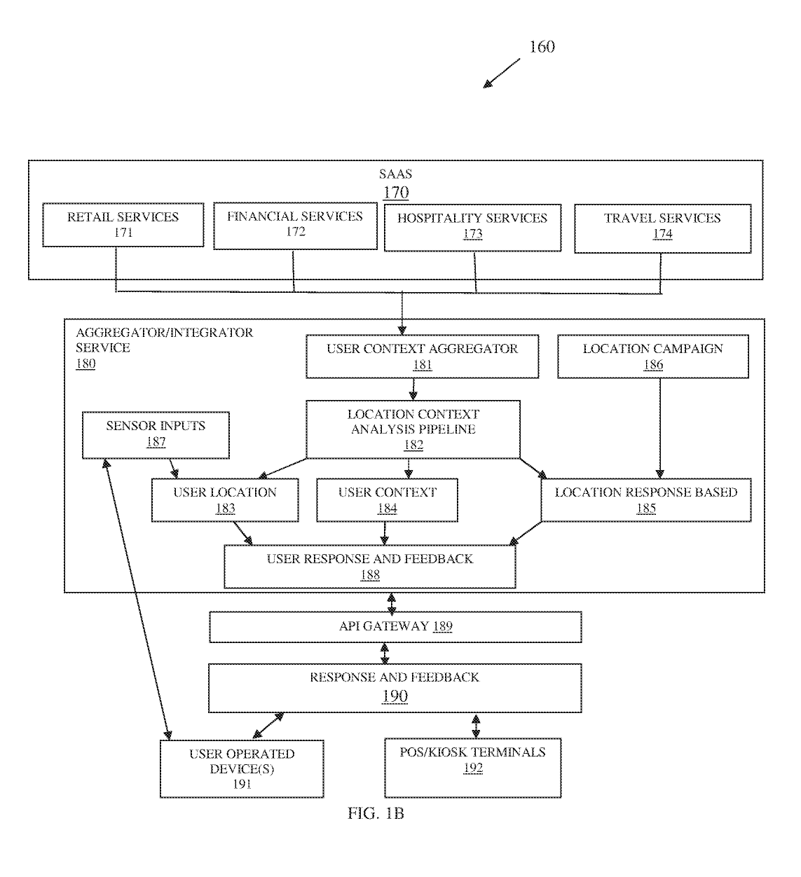

FIG. 1A is a diagram of a system 100 for location context aware computing, according to an example embodiment. The system 100 is shown schematically in greatly simplified form, with only those components relevant to understanding of one or more embodiments (represented herein) being illustrated. The various components are illustrated and the arrangement of the components is presented for purposes of illustration only. It is to be noted that other arrangements with more or less components are possible without departing from the location context aware computing techniques presented herein and below.

Moreover, various components are illustrated as one or more software modules, which residing in non-transitory storage and/or hardware memory as executable instructions that when executed by one or more hardware processors perform the processing discussed herein and below.

The techniques, methods, and systems presented herein and below for location context aware computing can be implemented in all, or some combination of the components shown in different hardware computing devices having one or more hardware processors.

The system 100 includes various lines of business (LOB) data repositories 110, a context aggregator 120, an integration service 130, a variety of online systems 140 (or online services accessible electronically over a network (wired, wirelessly, or a combination of wired and wireless)), and at least one user device operated by a user (or a customer of one of the online systems 140).

The LOB repositories 110 maintain transaction data for consumers within these different LOB repositories 110. The transaction data can include such things as: purchases, entertainment ticket redemption, gaming, social media, and the like. Again, a consumer's activity can be captured in one of these LOB repositories 110 based on activity performed on the user-operated device 150 or based on an operator of one or more of the online systems 140 causing the consumer's activity to be captured and entered into one or more of the LOB repositories 110.

In the embodiment, illustrated in the FIG. 1A, the LOB repositories 110 include for: entertainment 110A, apparel 110B, food 110C, travel 110D, hospitality 110E, finance 110F, and retail 110G.

The transaction data (purchases, social media transactions, venue ticket redemption, gaming, etc.) may be initially captured by a variety of online systems 140 or provided from online systems 140 to third-parties for management within the LOB repositories 110. In fact, some of this data within the LOB repositories 110 can be purchased by third-parties for reselling to other marketers, retailers, etc.

The context aggregator 120 is one or more software modules represented as executable instructions that execute on one or more processors of one or more network devices. The integration service 130 is one or more software modules represented as executable instructions that execute on one or more processors of one or more network devices.

The integration service 130 interacts with the context aggregator 120 for purposes of establishing an aggregated location context for a given consumer.

It is to be noted herein and below that the phrase “location context” as used herein includes location plus additional factors that are relevant to a consumer. That is location context is meant to be more than just a current resolved location for the consumer.

During operation of the system 100, the integrator service 130 interacts with the context aggregator 120 for purposes of assembling data for consumers across the lines of business (LOB) 110. This big data from multiple channels is aggregated by the context aggregator 120. Patterns are derived for specific consumers from the aggregated multi-channel transaction data.

Based on dates of the aggregated transaction data, additional external events can be added when deriving the patterns. For example, dates can reveal external events, such as a sporting event, a political event, a weather event, a catastrophic event, and the like. Moreover, the dates can link to days of the week. This added information about dates for the transaction data can be maintained in a separate file accessible to the context aggregator 120 and linkable with the transaction data based on each transaction's date and time-of-day.

The context aggregator 120 mines the transaction data for a specific customer or a customer segment associated with a classification of customers. (As used herein and below the terms “consumer,” “customer,” and “user” may be used interchangeably and synonymously.)

It is noted that the transactional data may also include location data for the transaction, such as at store X located geographically at address Y or using Point-Of-Sale (POS)/kiosk terminal Z.

Transactional data across the multiple LOB 110 for a given customer or customer segment is pooled together. The context aggregator 120 then integrates the external event data with the aggregated pool of transactional data for the given customer or customer segment.

The context aggregator 120 then processes the aggregated transaction data looking for predefined patterns or discoverable patterns that repeat in the augmented (including the external event data) and aggregated transactional data for the customer or customer segment.

The end result of the processing is a series of context produced by the context aggregator 120 represented by the derived patterns or the matched patterns to the predefined patterns. The context is a “location context” pattern because it includes location data and includes a variety of other data represented in the transaction data and integrated event data (based on time-of-day, day of week, calendar date).

Once these location context patterns are determined, the aggregated location context patterns are provided back to the integration service 130 for a given customer or customer segment. It is to be noted that each customer or customer segment may have their own aggregated location context patterns that are readily retrievable for processing by the integration service 130.

It is also noted that the context aggregator 120 may process at predefined intervals or based on events to continually update the location context patterns for the customers and the customer segments.

At this point, the integration service 130 is in the position to begin to provide location context aware computing for the customers and customer segments.

In an embodiment, a mobile application processes on a user-operated device, such as a mobile phone 150, of a given customer. This mobile application is continually reporting (or reporting on predefined intervals) a geographical location of the mobile phone 150. The integration service 130 receives this geographical location along with an identifier of the mobile application or the mobile device for purposes of uniquely identifying the given customer. Additionally, the integration service 130 is continually receiving real-time transaction data for any transactions that the customer may be engaging in from the online systems 140 (POS terminals and/or kiosks of enterprises associated with the LOB 110).

In an embodiment, the integration service 130 then weights this information for the real-time transaction data with the geographic location of the mobile phone 150 for the given customer and creates a score which can be compared to other scores pre-assigned to the given location context patterns for the customer to find a likely match (when the score of the current location context is within a predefined range of a score for one of the existing location context patterns for the customer).

Once a match is found, the integration service 130 can send (through perhaps an Application Programming Interface (API)) the matched location context pattern to an online system 140 for purposes of making a real-time offer or suggestion for purchasing an item directly the customer (through that online system's mobile application processing on the customer's mobile device 150). This processing of the integration service 130 provides the online systems 140 with “location context aware” computing for the given customer in real time or near real time as the customer is in a given context and a given location, such that more lucrative real-time offers or suggestions for purchasing an item (can also be a service) can be made directly by the online systems 140. It is also noted that the real-time offer or suggestions for purchasing can be made through a POS terminal or a kiosk of the online system 140 when the customer (present in a store of the online system 140) checks out with an item.

In another case, the integration service 130 can already have available offers or subscribed online systems 140 (subscribed to access location context computing services of the integration service 130). These offers include a schema that define the offer and conditions of the offer, which the integration service 130 can evaluate in view of the customer and the matched location context pattern. The integration service 130 can then determine a location context aware real-time offer or suggestion for purchasing and deliver such offer or suggestion through the mobile application processing on the mobile device 150 of the customer and in communication with the integration service.

Still further, the integration service 140 notes actions taken by the customer within the location context aware settings with respect to actions or non-actions taken subsequent to the real-time offers or suggestions. This can be communicated through the online systems 140 (again through API calls) or can be communicated through real-time transaction data communicated from an online system 140 when the customer makes a next transaction with an enterprise. This creates a feedback loop between the location context aware real-time offers or suggestions and actions or inaction taken by the customer. It is also noted that the online system 140 associated with the real-time offer or suggestion need not be the online system 140 from which the dynamic feedback is noted for the customer (there can be different enterprises involved with the offer versus the next action of the customer).

The dynamic feedback is used to learn what actions the customer is taking with respect to the location context aware offers or suggestions. For example, if in a given context, such as every Monday between 10 am and 11 am, Joe busy a cup of coffee at a local coffee shop and is offered a coupon for buying a pound of the coffee, Joe does not buy the coffee but rather buys flowers at a nearby florist, then the real-time offer for buying a pound of coffee can be changed to an upgrade purchase at the florist. This new real-time offer to Joe for the upgraded purchase at the florist can also be tracked through feedback by the integration service 130 for purposes of determining if in the given context the real-time offer should be further altered for Joe. As another situation, suppose that Joe has a location context pattern where Joe when traveling at an airport regularly buys something to eat at a store in the airport before boarding when Joe has not recently purchased something to eat before arriving at the airport. Joe can be provided a real-time offer for a discount on a different airport eatery when the location context aware setting for Joe is detected in real time to see whether Joe will change and purchase at the different airport eatery. If Joe redeems the offer, the success is noted and Joe is subsequently offered a same or similar discount at the airport eatery, and the success or failures are noted and adjusted as needed.

The integration service 130 through tracking and feedback of location context aware situations for customers begins to learn what works with the customers based on successes and failures that are recorded and noted in the dynamic feedback for given location contexts. The feedback drives a customized subsequent offer to a given consumer within a given location context aware situation.

In an embodiment, the integration service 130 is initially trained on predefined location context aware successes and failures for a given customer or customer segment, so that the initial location context aware real-time offers or suggestions are believed to be something the customer will redeem or purchase in those given location context aware situations.

In an embodiment, the location context aware real-time offers or suggestions and dynamic feedback modifications are based on a user-system (retailer) specific customer segment.

In an embodiment the online systems 140 (retailers) can link through an API existing campaign management offers or suggestions that the integration service 130 matches to for making the offers or suggestions to specific consumers within location context aware situations that the integration service 130 believes are likely to be successful based on the ongoing real-time modifications to what offers or suggestions are believed to be successful with those specific consumers.

In an embodiment, the integration service 130 employs multiple machine learning techniques to learn what offers or suggestions are likely to be successful with a given consumer or given customer segment.

In an embodiment, the integration service 130 uses multiple streams of real-time transaction data and location data for consumers occurring over the multiple channels associated with the LOB 110, such that processing throughput is improved and/or parallel processing is achieved when scoring real time location context aware situations for the customers and when picking a real-time offer or suggestion for the customers within a given location context aware situation. This can substantially improve memory usage and processing throughput of the server or servers having the integration service 130 or independent processing instances of the integration service 130.

The FIG. 1B is now discussed with additional features that can be provided through the novel processing of the context aggregator 120 and the integration service 130 when providing location context aware computing.

FIG. 1B is a diagram a sample architecture 160 for practicing location context aware computing according to an example embodiment.

The architecture 160 includes a plurality of Software-as-a-Service (SaaS) 170, an aggregator/integrator service 180, an API gateway 189, a response and feedback module 190, user-operated devices 191, and a plurality of POS/kiosk terminals 192 associated with one or more online systems 140.

The SaaS 170 include (in this sample embodiment) retail services 171, financial services 172, hospitality services 173, and travel services 174.

The aggregator/integration service 180 includes sub-processing modules and data modules that include: a user-context aggregator 181, a location context analysis pipeline 182, a user location module 183, a user context module 184, a location response based module 185, a plurality of sensor inputs 187, and a user response and feedback module 188.

In the embodiment described in the architecture 160, provides the same features available to a customer or retailer (online system 140) through the user device 150 of POS/Kiosk terminals 192 that are available as was discussed above with the description of the FIG. 1A. Therefore, the user device 150 although not specifically referenced in the FIG. 1B will be referenced in some of the illustrated feature processing discussed with the architecture 160 as user-operated devices 191. Similarly, each online system 140 can include a plurality of the POS/Kiosks 192 in the FIG. 1B. Moreover, the aggregator/integrator service 180 may be viewed as the combination of the context aggregator 120 and the integrator service 130 discussed in the FIG. 1A.

The architecture 160 includes processing for providing location context aware computing for customers and retailers associated with the POS/Kiosk terminals 192.

The architecture 160 provides improved processing throughput and memory management through deploying pipelines and parallel processing. It is to be noted that the modules represented may processing in parallel on a variety of computing platforms.

User location contexts are aggregated by the user context aggregator 181 for historical transaction data from the SaaS 170 available transaction data and augmented with event data and time data as discussed above. Moreover, the historical transaction data includes location data for where the transactions were geographically performed as discussed above.

The location context analysis pipeline 182 provides the processing for resolving specific real-time location context aware situations against real-time data being fed through the SaaS for real-time transactions of a given customer. This is delegated to the user location module 183 for obtaining a current and real-time geographical location of the customer as provided by sensor inputs (user-operated device mobile application reporting real-time location data for the user-operated device 191, customer identifiers being provided through a variety of sensors located at the POS/Kiosk terminals 192, this may also include schedule or itinerary information available for a customer and communicated through the API gateway 189, other types of sensor input can provide the geographical location data for the user (customer) as well.

In an embodiment, the sensors 187 and/or the terminals 192 include any processor-enabled device with sensing capabilities, such as devices referred to as the Internet of Things (IoTs). These IoTs communicate over a network, such as the Internet, to get receive and send small bits of information. In this way, more than just transactional awareness can be achieved with the many teachings provided herein and below with location context aware situations, such as detecting a context aware situation where lights should be turned on when a customer enters a room, automatically moving a clothing or jewelry carrousel when the presence of a customer is detected and based on the location context aware situation of the customer to provide the customer with selections most likely to be of interest to the customer. Thus, the sensors 187 can be integrated through retail locations or even within the customer's home and car providing location presence information for the customer and feeding into a current location context aware situation calculation for providing that customer with real-time relevant information or physical responses from other IoTs in proximity the customer.

The user context module 184 provides the real-time location context aware information for the customer providing a current location context pattern from the customer that includes the location data (as coordinated by the location context analysis pipeline).

The location response based module 185 matches the location context aware (the context and location) for the customer in real time with the aggregated location context patterns identified for the customer. The location response based module also receives the location campaign information 186 defined by retailers (online systems 140) as input to take matched location context aware situations of the customer with the predefined location context patterns and identify a real-time offer or suggestion to link to the customer at the customers given location within the given matched location context aware situation.

The location response based module 185 then provides the real-time offer or suggestion to the user response and feedback module 188, which sends the real-time offer or suggestion through the API gateway for communication with the response and feedback module 190. The response and feedback module 190 delivers the real-time offer or suggestion directly to a POS/Kiosk terminal 192 that the customer is currently or believed to soon be transaction at (soon to be because the customer may be in the store associated with the POS/Kiosk terminal 192 but has yet to engage in any transaction). The response and feedback module 190 may also deliver the real-time offer or suggestion to the mobile application processing on the user-operated device 191 when the customer is in a given matched and resolved location context aware situation.

The current location context aware situation for the customer is continually, periodically, and regularly resolved and actions (transaction actions) subsequently taken after delivery of the real-time offer or suggestion are monitored and received back from the same or different POS/Kiosk terminal 192 and/or from the mobile application of the user-operated device 191. These actions may indicate a redemption of the offer or purchase of a good or service associated with the suggestions. Alternatively, these actions may indicate the purchase of something different entirely from the offer or suggestion. Still further, non-action after a preconfigured period of time may be noted and recorded as a failure with respect to the real-time offer or suggestion.

Any subsequent action is reported up through the response and feedback module 190 through the API gateway 189 to the user response and feedback module 188, which is updated based on success or failure to alter and modify the type of real-time offers or suggestions selected from the location campaigns 186 when the customer is detected in a same location context aware situation as that which was associated with the customer when the original real-time offer or suggestion was provided to the customer.

It is now appreciated how the aggregator/integrator service 180 aggregates location context patterns and matches a real-time location context aware to one or more of those patterns and then continually learns what types of real-time offers or suggestions are liked and work with the customer within that location context situation and what types of real-time offers or suggestions do not worked and presumed disliked by the customer within that location context situation. This provides location context aware computing in a processor and memory efficient manner in real-time and is continually adjusted based on dynamic feedback and/or machine learning.

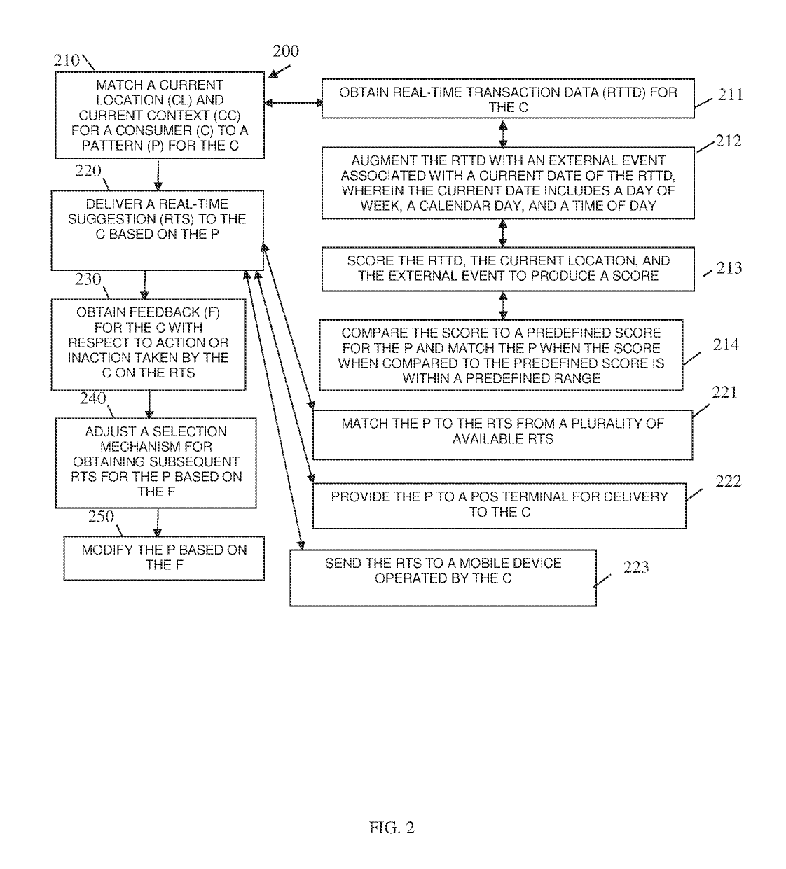

These and other embodiments are no discussed with reference to the FIGS. 2-4.

FIG. 2 is a diagram of a method 200 for location context aware computing, according to an example embodiment. The software module(s) that implements the method 300 is referred to as an “location context aware manager.” The location context aware manager is implemented as executable instructions programmed and residing within memory and/or a non-transitory computer-readable (processor-readable) storage medium and executed by one or more hardware processors of a hardware computing device. The processors of the device that executes the location context aware manager are specifically configured and programmed to process the location context aware manager. The location context aware manager has access to one or more networks during its processing. The networks can be wired, wireless, or a combination of wired and wireless.

In an embodiment, the device that executes the location context aware manager is a server.

In an embodiment, the device that executes the location context aware manager is a cloud processing environment having a variety of hardware devices logically organized as a single processing environment.

In an embodiment, location context aware manager is the context aggregator 120 and the integration service 130.

In an embodiment, the location context aware manager is the aggregator/integrator 180.

At 210, the location context aware manager matches a current location and current context for a consumer to a pattern for a consumer. This can be done in the manners described above with respect to the FIGS. 1A and 1B.

According to an embodiment, at 211, the location context aware manager obtains real-time transaction data for the consumer. The transaction data includes location data for the consumer and any of the types of data described above with the FIG. 1A.

In an embodiment of 211 and at 212, the location context aware manager augments the real-time transaction data with an external event associated with a current date of the real-time transaction data. The current data includes a day of the week, a calendar day, and a time of day. So, the real-time transaction data is integrated with the external event data.

In an embodiment of 212 and at 213, the location context aware manager scores the real-time transaction data, the current location, and the external event data to produce a score.

In an embodiment of 213 and at 214, the location context aware manager compares the score to a predefined score for the pattern and matches the pattern when the score when compared to the predefined score is within a predefined range.

At 220, the location context aware manager delivers a real-time suggestion or offer to the consumer based on the pattern. This can be done in any of the manners discussed above with respect to the FIGS. 1A and 1B.

According to an embodiment, at 221, the location context aware manager matches the pattern to the real-time suggestion or offer from a plurality of available real-time suggestions. In an embodiment, each of the plurality of available real-time suggestions is linked to one or more campaigns.

In an embodiment, at 222, the location context aware manager provides the pattern to a POS/kiosk terminal for delivery to the consumer while the consumer is conducting a transaction at the POS/kiosk terminal or when it is predicted that the consumer will eventually conduct a transaction at the POS/kiosk terminal based on the consumer being within a configured distance of the POS/kiosk terminal.

In an embodiment, at 223, the location context aware manager sends the real-time suggestion to a mobile device operated by the consumer, such as through a mobile application processing on the mobile device.

According to an embodiment, at 230, the location context aware manager obtains feedback for the consumer with respect to action or inaction (within a configured period of time) taken by the consumer on the real-time suggestion.

In an embodiment of 230 and at 240, the location context aware manager adjusts a second mechanism for obtaining subsequent real-time suggestions for the pattern based on the feedback.

In an embodiment of 240 and at 250, the location context aware manager modifies the pattern based on the feedback. Thus, the suggestion mechanism for the real-time suggestion and the patterns used for matching the current location and the current context of the consumer can both be modified based on the feedback.

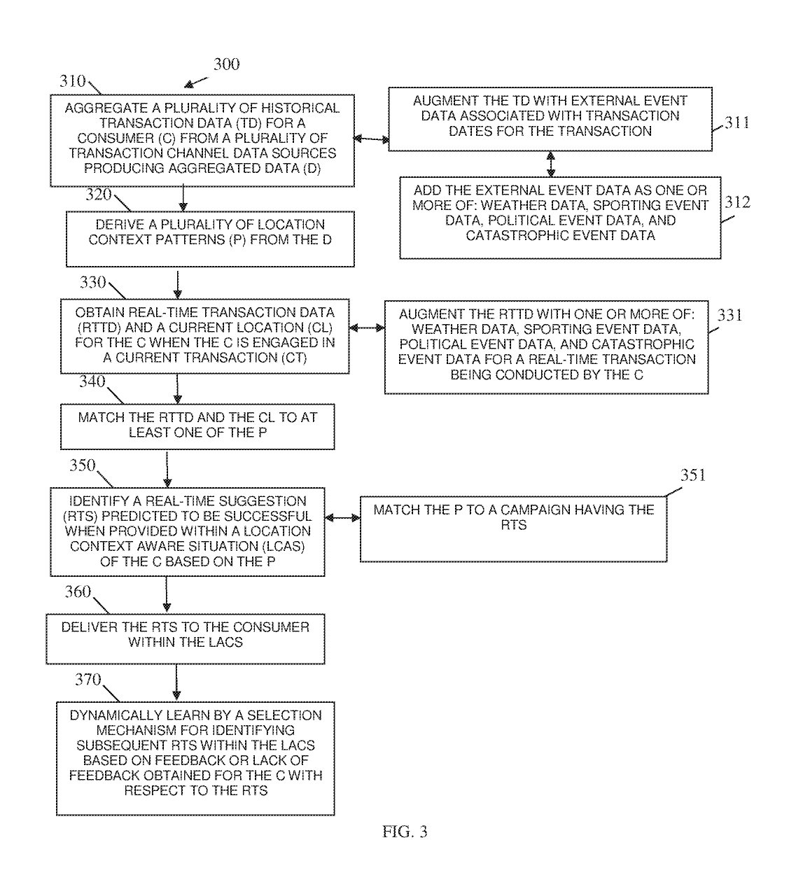

FIG. 3 is a diagram of another method 300 for location context aware computing, according to an example embodiment. The software module(s) that implements the method 300 is referred to as an “aggregator/integrator service.” The aggregator/integrator service is implemented as executable instructions programmed and residing within memory and/or a non-transitory computer-readable (processor-readable) storage medium and executed by one or more hardware processors of a hardware device. The processors of the device that executes the aggregator/integrator service are specifically configured and programmed to process the aggregator/integrator service. The aggregator/integrator service has access to one or more networks during its processing. The networks can be wired, wireless, or a combination of wired and wireless.

In an embodiment, the device that executes the aggregator/integrator service is a server.

In an embodiment, the device that executes the aggregator/integrator service is a proxy to an online system 140.

In an embodiment, the device that executes the aggregator/integrator service is a cloud processing environment.

In an embodiment, the aggregator/integrator service is the context aggregator 120 and the integration service 130.

In an embodiment, the aggregator/integrator service is the aggregator/integrator 180.

In an embodiment, the aggregator/integrator service is the method 200 of the FIG. 2.

In an embodiment, the aggregator/integrator service is some combination of the context aggregator 120, the integration service 130, the aggregator/integrator 180, and the method 200 of the FIG. 2.

At 310, the aggregator/integrator service aggregates a plurality of historical transaction data for a consumer from a plurality of transaction channel data sources producing aggregated data. In an embodiment, the transaction data is the transaction data described above in the FIG. 1A. In an embodiment, the channel data sources are the SaaS 170 of the FIG. 1B. In an embodiment, the channel data sources are any, some combination, or all of the LOB 110 sources of the FIG. 1A.

In an embodiment, at 311, the aggregator/integrator service augments the transaction data with external event data associated with transaction dates for the transaction.

In an embodiment of 311 and at 312, the aggregator/integrator service adds the external event data as one or more of: weather data, sporting event data, political event data, and catastrophic data.

At 320, the aggregator/integrator service derives a plurality of location context patterns from the aggregated data for the consumer.

At 330, the aggregator/integrator service obtains real-time transaction data and a current location for the consumer when the consumer is engaged in a current transaction.

According to an embodiment, at 331, the aggregator/integrator service augments the real-time transaction data with one or more of: weather data, sporting event data, political event data, and catastrophic event data for a real-time transaction being conducted by the consumer.

At 340, the aggregator/integrator service matches the real-time transaction data and the current location to at least one of the location context patterns.

At 350, the aggregator/integrator service identifies a real-time suggestion predicted to be successful when provided within a location context aware situation of the consumer and based on the pattern.

In an embodiment, at 351, the aggregator/integrator service matches the pattern to a campaign having the real-time suggestion.

At 360, the aggregator/integrator service delivers the real-time suggestion to the consumer within the location context aware situation.

In an embodiment, at 370, the aggregator/integrator service dynamically learns, by a selection mechanism, for identifying subsequent real-time suggestions within the location context aware situation based on feedback or lack of detected feedback obtained for the consumer with respect to the real-time suggestion.

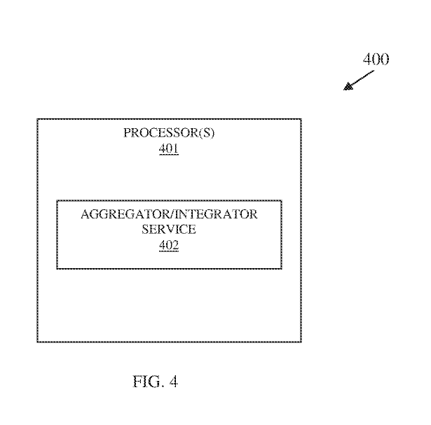

FIG. 4 is a diagram of a system 400 for location context aware computing, according to an example embodiment. The system 400 includes a variety of hardware components and software components. The software components of the system 400 are programmed and reside within memory and/or a non-transitory computer-readable medium and execute on one or more hardware processors of a hardware device. The system 400 communicates one or more networks, which can be wired, wireless, or a combination of wired and wireless.

In an embodiment, the system 400 implements all, any, or some combination of the processing discussed above with the FIGS. 1A-1B and 2-3.

The system 400 includes at least one hardware processor 401 and an aggregator/integration service 402.

In an embodiment, the hardware processor 401 is part of a server.

In an embodiment, the hardware processor 401 is part of a proxy for an online system 140.

In an embodiment, the hardware processor is part of a cloud processing environment.

The aggregator/integration service 402 is configured to: execute on the processor 401, identify location context aware situations for a consumer, make a real-time suggestion to the consumer based on a current location context situation for the consumer, and learn how to make subsequent real-time suggestions to the consumer based on feedback obtained for the consumer with respect to the real-time suggestion.

In an embodiment, the aggregator/integrator service 402 is configured to: aggregate multiple channels of transaction data for the consumer and derive location context patterns from the aggregated transaction data, and identify the location context situation by matching a current location having current transaction data for the consumer to one of the location context patterns.

In an embodiment, the aggregator/integrator service 402 is configured to one of: deliver the real-time suggestion to a mobile device operated by the consumer and deliver the real-time suggestion to a Point-Of-Sale terminal at which the consumer is currently transacting with or at which the consumer is believed to be transacting with within a predefined period of time.

In an embodiment, aggregator/integration service 402 is the context aggregation 120 and the integration service 130.

In an embodiment, the aggregator/integration service 402 is the aggregator/integrator service 180.

In an embodiment, the aggregator/integration service 402 is the method 200 of the FIG. 2.

In an embodiment, the aggregator/integration service 402 is the method 300 of the FIG. 3.

In an embodiment, the aggregator/integration service 402 is deployed as a Software as a Service (SaaS) over a network.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
matching a current location and current context for a consumer to a pattern for the consumer; and
delivering a real-time suggestion to the consumer based on the pattern.

2. The method of claim 1 further comprising, obtaining feedback for the consumer with respect to action or inaction taken by the consumer on the real-time suggestion.

3. The method of claim 2 further comprising, adjusting a selection mechanism for obtaining subsequent real-time suggestions for the pattern based on the feedback.

4. The method of claim 3 further comprising, modifying the pattern based on the feedback.

5. The method of claim 1, wherein matching further includes obtaining real-time transaction data for the consumer.

6. The method of claim 5, wherein obtaining further includes augmenting the real-time transaction data with an external event associated with a current date of the real-time transaction data, wherein the current date includes a day of week, a calendar day, and a time of day.

7. The method of claim 6, wherein augmenting further includes scoring the real-time transaction data, the current location, and the external event to produce a score.

8. The method of claim 8, wherein scoring further includes comparing the score to a predefined score for the pattern and matching the pattern when the score when compared to the predefined score is within a predefined range.

9. The method of claim 1, wherein delivering further includes matching the pattern to the real-time suggestion from a plurality of available real-time suggestions.

10. The method of claim 1, wherein delivering further includes providing the pattern to a Point-Of-Sale (POS) terminal for delivery to the consumer.

11. The method of claim 1, wherein delivering further includes sending the real-time suggestion to a mobile device operated by the consumer.

12. A method, comprising:
aggregating a plurality of historical transaction data for a consumer from a plurality of transaction channel data sources producing aggregated data;
deriving a plurality of location context patterns from the aggregated data;
obtaining real-time transaction data and a current location for the consumer when the consumer is engaged in a current transaction;
matching the real-time transaction data and the current location to at least one of the location context patterns;
identifying a real-time suggestion predicted to be successful when provided within a location context aware situation of the consumer based on the pattern; and
delivering the real-time suggestion to the consumer within the location context aware situation.

13. The method of claim 12, wherein aggregating further includes augmenting the historical transaction data with external event data associated with transaction dates for the transaction.

14. The method of claim 13, wherein augmenting further includes adding the external event data as one or more of: weather data, sporting event data, political event data, and catastrophic event data.

15. The method of claim 12, wherein obtaining further includes augmenting the real-time transaction data with one or more of: weather data, sporting event data, political event data, and catastrophic event data for a real-time transaction being conducted by the consumer.

16. The method of claim 12, wherein identifying further includes matching the pattern to a campaign having the real-time suggestion.

17. The method of claim 12 further comprising, dynamically learning by a selection mechanism for identifying subsequent real-time suggestions within the location context aware situation based on feedback or lack of feedback obtained for the consumer with respect to the real-time suggestion.

18. A system, comprising:
a hardware processor;
an aggregator/integrator service configured to: (i) execute on the hardware processor; (ii) identify location context aware situations for a consumer, iii) make a real-time suggestion to the consumer based on a current location context situation for the consumer, and iv) learn how to make subsequent real-time suggestions to the consumer based on feedback obtained for the consumer with respect to the real-time suggestion.

19. The system of claim 18, wherein the aggregator/integrator service is configured, in ii), to: aggregate multiple channels of transaction data for the consumer and derive location context patterns from the aggregated transaction data, and identify the location context situation by matching a current location having current transaction data for the consumer to one of the location context patterns.

20. The system of claim 19, the aggregator/integrator service is configured, in iii), to one of: deliver the real-time suggestion to a mobile device operated by the consumer and deliver the real-time suggestion to a Point-Of-Sale terminal at which the consumer is currently transacting with or at which the consumer is believed to be transacting with within a predefined period of time.
